(19) United States
(12) Patent Application Publication
(10) Pub. No.: US 2011/0187289 A1
(43) Pub. Date: Aug. 4, 2011

(54) LIGHT SOURCE DRIVER

(75) Inventors: Hyo Young KIM, Suwon (KR); Jong Rak KIM, Suwon (KR); Sung Hun OH, Suwon (KR); Doo Ho YOO, Ulsan (KR)

(73) Assignee: SAMSUNG ELECTRO-MECHANICS CO., LTD., Suwon (KR)

(21) Appl. No.: 13/018,481

(22) Filed: Feb. 1, 2011

(30) Foreign Application Priority Data
Feb. 3, 2010 (KR) 10-2010-0009992

(51) Int. Cl. H05B 37/02

(52) U.S. Cl. 315/307

(57) ABSTRACT

A light source driver supplies a driving voltage, obtained by the multiplication of an input voltage, to a light source, especially to an LED array. The light source driver includes a power converting part switching an input power to be converted into a first power having a predetermined voltage level; and a multiplying part including at least one multiplying cell having at least one capacitor charging and discharging the first power according to the switching of the power converting part and at least one diode providing a path for transmitting the first power according to the switching of the power converting part, multiplying the first power to thereby transmit a driving power to at least one light source, and being configured as a closed loop in which the capacitor and the diode are connected to an input terminal of the power converting part through which the input power is inputted.

### CROSS-REFERENCE TO RELATED APPLICATIONS

This application claims the priority of Korean Patent Application No. 10-2010-0009992 filed on Feb. 3, 2010, in the Korean Intellectual Property Office, the disclosure of which is incorporated herein by reference.

### BACKGROUND OF THE INVENTION

1. Field of the Invention

The present invention relates to a light source driver, and more particularly, to a light source driver capable of supplying a driving voltage, obtained by the multiplication of an input voltage, to a light source emitting light, especially to a light emitting diode array.

2. Description of the Related Art

With the advent of the information age, the demand for a high performance display capable of presenting information in various formats such as images, graphics and text for the rapid transmission thereof has been rapidly increasing. In order to meet the demand for such, the display industry is undergoing rapid growth.

Particularly, a Liquid Crystal Display (LCD) has been greatly improved as a next-generation high-tech display device in recent years since it has low power consumption and is relatively thin and lightweight as compared with a cathode ray tube (CRT). The LCD has been widely used in an electronic watch, an electronic calculator, a computer, a television and the like.

Meanwhile, the LCD includes a liquid crystal panel displaying an image and a backlight unit supplying light to the liquid crystal panel.

The liquid crystal panel is formed of a thin-film transistor substrate including a gate line, a data line, a thin-film transistor, a pixel electrode and the like, and a color filter substrate including a color filter, a common electrode and the like. When a pixel voltage is applied to the liquid crystal panel, the liquid crystal panel is driven to adjust the transmittance of the light supplied by the backlight unit so that it can display an image.

A fluorescent lamp or a light emitting diode (LED) may be used as the backlight unit. In the case of an LED, for example, a plurality of LED arrays, each having a plurality of series-connected LEDs, may be used as a light source of the backlight unit. Here, when more LEDs are employed, a higher driving voltage is required.

In order to supply the required voltage, a power circuit having a transformer or a switching circuit is employed. However, as the number of the LEDs being employed increases, the driving voltage may not reach a desired level due to limitations in the switching duty of a switch. Further, the current increase in a primary side of the transformer may cause heat generation in the switch and the winding of the transformer so that product temperature may be increased.

These problems may also be caused in a backlight unit employing a fluorescent lamp requiring a very high driving voltage.

### SUMMARY OF THE INVENTION

An aspect of the present invention provides a light source driver capable of supplying a driving voltage, obtained by the multiplication of an input voltage, to a light source emitting light, especially to a light emitting diode array.

According to an aspect of the present invention, there is provided a light source driver including: a power converting part switching an input power to be converted into a first power having a predetermined voltage level; and a multiplying part comprising at least one multiplying cell having at least one capacitor charging and discharging the first power according to the switching of the power converting part and at least one diode providing a path for transmitting the first power according to the switching of the power converting part, multiplying the first power to thereby transmit a driving power to at least one light source, and being configured as a closed loop in which the at least one capacitor and the at least one diode are connected to an input terminal of the power converting part through which the input power is inputted.

The multiplying part may include a first multiplying cell and a second multiplying cell. The first multiplying cell may include a first capacitor having one end connected to the power converting part and the other end connected to the second multiplying cell; and a first diode having a cathode connected to the other end of the first capacitor and an anode connected to the input terminal of the power converting part. The second multiplying cell may include a second capacitor having one end connected to the other end of the first capacitor of the first multiplying cell and the other end connected to an output terminal of the driving power; a second diode having an anode connected to the cathode of the first diode of the first multiplying cell and a cathode; a third diode having an anode connected to the cathode of the second diode and a cathode connected to the other end of the second capacitor; and a third capacitor having one end connected to a connecting node between the cathode of the second diode and the anode of the third diode and the other end connected to the input terminal of the power converting part.

The multiplying part may further include a plurality of multiplying cells between the second multiplying cell and the output terminal. The second multiplying cell may include a plurality of second multiplying cells and the plurality of multiplying cells may be the plurality of second multiplying cells connected in series.

The light source may be at least one selected from the group consisting of at least one light emitting diode (LED), a fluorescent lamp, or at least one LED array including a plurality of series-connected LEDs.

The power converting part may include an inductor charging an energy of the input power; and a switch switching the energy charged in the inductor.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view illustrating the configuration of a light source driver according to an exemplary embodiment of the present invention; and

FIG. 2 is a graph illustrating the electrical characteristics of a light source driver according to an exemplary embodiment of the present invention.

### DETAILED DESCRIPTION OF THE PREFERRED EMBODIMENT

Exemplary embodiments of the present invention will now be described in detail with reference to the accompanying drawings.

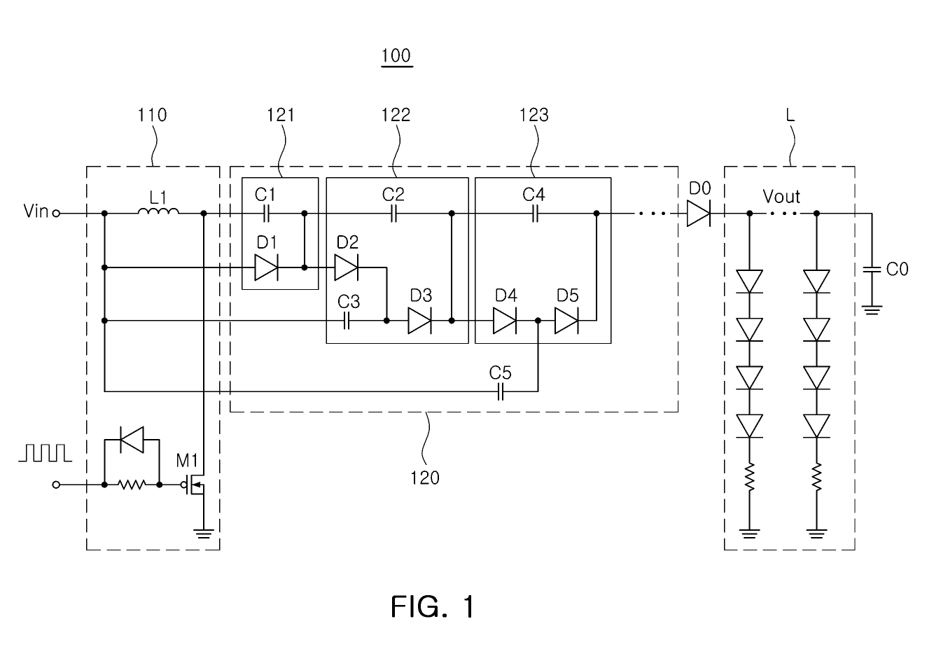

FIG. 1 is a schematic view illustrating the configuration of a light source driver according to an exemplary embodiment of the present invention.

With reference to FIG. 1, a light source driver 100 may include a power converting part 110 and a multiplying part 120.

The power converting part 110 may include an inductor L1 storing the energy of an input power Vin and a switch M1 switching the energy stored in the inductor L1 to be converted into a first power having a predetermined voltage level.

The multiplying part 120 may include a plurality of multiplying cells 121, 122 and 123.

That is, the number of the multiplying cells may be selected according to the desired degree of the multiplication of the first power inputted from the power converting part 110.

For example, when the first power is multiplied once, only a first multiplying cell 121 may be included. When the first power is multiplied twice, first and second multiplying cells 121 and 122 may be included. When the first power is multiplied thrice, first, second and third multiplying cells 121, 122 and 123 may be included.

The first multiplying cell 121 may include a first capacitor C1 and a first diode D1.

The first capacitor C1 may have one end connected to a connecting node between the inductor L1 and the switch M1 and the other end connected to the second multiplying cell 122. The first diode D1 may have a cathode connected to the second multiplying cell 122, along with the other end of the first capacitor C1, and an anode connected to an input terminal through which the input power Vin is inputted to the inductor L1. That is, a closed loop connected to the input terminal may be configured.

The second multiplying cell 122 may include second and third capacitors C2 and C3 and second and third diodes D2 and D3.

The second capacitor C2 may have one end connected to a connecting node between the first capacitor C1 and the first diode D1 and the other end connected to the third multiplying cell 123. The second diode D2 may have a cathode connected to an anode of the third diode D3 and an anode connected to the cathode of the first diode D1. A cathode of the third diode D3 may be connected to the third multiplying cell 123. The third capacitor C3 may have one end connected to a connecting node between the cathode of the second diode D2 and the anode of the third diode D3 and the other end connected to the input terminal.

Accordingly, another closed loop connected to the input terminal may be configured.

The third multiplying cell 123 and subsequent multiplying cells may be configured in the same manner as the second multiplying cell 122. For example, the third multiplying cell 123 may include fourth and fifth capacitors C4 and C5 and fourth and fifth diodes D4 and D5.

The fourth capacitor C4 may have one end connected to a connecting node between the second capacitor C2 and the third diode D3 of the second multiplying cell 122 and the other end connected to the next multiplying cell or an output terminal outputting a driving power. The fourth diode D4 may have a cathode connected to an anode of the fifth diode D5 and an anode connected to the cathode of the third diode D3. A cathode of the fifth diode D5 may be connected to the next multiplying cell or the output terminal. The fifth capacitor C5 may have one end connected to a connecting node between the cathode of the fourth diode D4 and the anode of the fifth diode D5 and the other end connected to the input terminal. Accordingly, another closed loop connected to the input terminal may be configured.

The driving power from the second multiplying cell 122, the third multiplying cell 123 or the next multiplying cell (not shown) may be stabilized by an output diode DO and an output capacitor CO and be then transmitted to a light source L. This light source L may be at least one selected from the group consisting of at least one light emitting diode (LED), a fluorescent lamp, or at least one LED array including a plurality of series-connected LEDs.

In the above-described multiplying cells 121, 122 and 123, the capacitors charge and discharge the first power inputted from the power converting part 110 according to the switching of the switch M1 and the diodes provide a transmission path therefor.

The third multiplying cell 123 operates in the same manner as the second multiplying cell 122, so a description will be given of the operations of the first and second multiplying cells 121 and 122.

First, in a state where the input power Vin is inputted, when the switch M1 is switched on, the first power is charged in the first capacitor C1 through the first diode D1.

Next, when the switch M1 is switched off, the energy stored in the inductor L1 and the voltage charged in the first capacitor C1 are charged in the third capacitor C3 so that a driving power Vout is outputted. Here, the voltage level of the driving power Vout may be the same as that of the first power.

When the switch M1 is switched on again, the voltage charged in the third capacitor C3 is discharged through the third diode D3 and charged in the second capacitor C2.

Then, when the switch M1 is switched off, the energy stored in the inductor L1 and the voltage charged in the first and second capacitors C1 and C2 are outputted as a driving power. Here, the voltage level of the driving power Vout may be equivalent to twice that of the first power.

By performing the above-described operations repeatedly, a stable driving power may be supplied to the light source L.

In the above-described closed loops, configured in the first and second multiplying cells 121 and 122, a charge and discharge path may revert to the input terminal, so that reactive power loss may be reduced. As for the first to third capacitors C1, C2 and C3, an SMD chip capacitor, a Multi Layer Ceramic Capacitor (MLCC) or the like may be employed by replacing a conventional electrolytic capacitor. Accordingly, the dimensions of a circuit and the production costs thereof may be reduced.

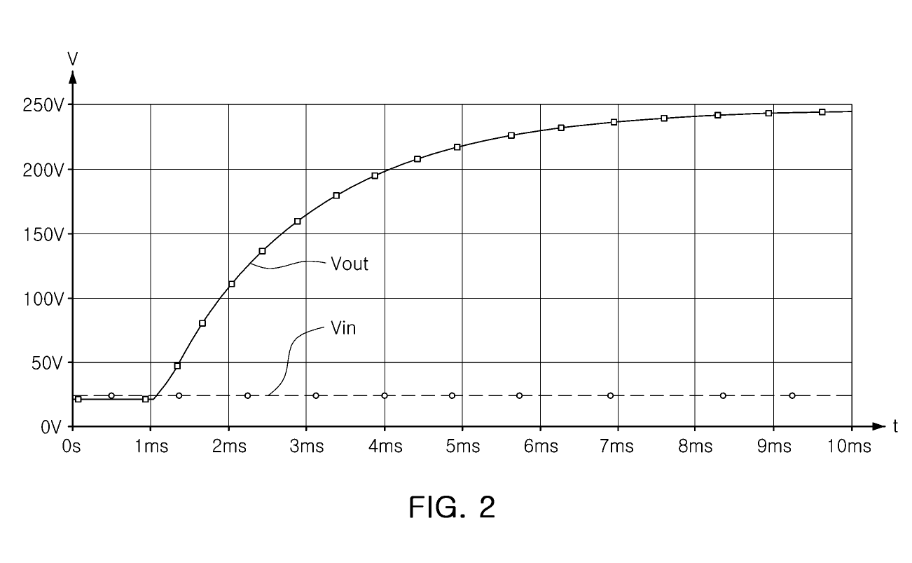

FIG. 2 is a graph illustrating the electrical characteristics of a light source driver according to an exemplary embodiment of the present invention.

With reference to FIG. 2, it can be seen that the input power is multiplied by the use of the configuration of the multiplying part 120 shown in FIG. 1 so that a stable driving power may be transmitted to the light source L.

As described above, a power is converted according to power switching and the converted power is multiplied through a multiplying circuit, so that heat generation caused by the conduction loss of a switching device or the winding of a transformer may be reduced. Furthermore, a path for power transmission in the multiplying circuit may revert to an input terminal to thereby reduce reactive power loss so that the dimensions of a circuit and the production costs thereof may be reduced.

As set forth above, according to exemplary embodiments of the invention, a light source emitting light, particularly a light emitting diode array is supplied with a driving voltage, obtained by the multiplication of an input voltage, and accordingly, heat generation in a switching device or the winding of a transformer may be reduced.

While the present invention has been shown and described in connection with the exemplary embodiments, it will be apparent to those skilled in the art that modifications and variations can be made without departing from the spirit and scope of the invention as defined by the appended claims.

What is claimed is:

1. A light source driver comprising:
a power converting part switching an input power to be converted into a first power having a predetermined voltage level; and
a multiplying part comprising at least one multiplying cell having at least one capacitor charging and discharging the first power according to the switching of the power converting part and at least one diode providing a path for transmitting the first power according to the switching of the power converting part, multiplying the first power to thereby transmit a driving power to at least one light source, and being configured as a closed loop in which the at least one capacitor and the at least one diode are connected to an input terminal of the power converting part through which the input power is inputted.

2. The light source driver of claim 1, wherein the multiplying part comprises a first multiplying cell and a second multiplying cell,
the first multiplying cell comprises:
a first capacitor having one end connected to the power converting part and the other end connected to the second multiplying cell; and
a first diode having a cathode connected to the other end of the first capacitor and an anode connected to the input terminal of the power converting part,
the second multiplying cell comprises:
a second capacitor having one end connected to the other end of the first capacitor of the first multiplying cell and the other end connected to an output terminal of the driving power;
a second diode having an anode connected to the cathode of the first diode of the first multiplying cell and a cathode;
a third diode having an anode connected to the cathode of the second diode and a cathode connected to the other end of the second capacitor; and
a third capacitor having one end connected to a connecting node between the cathode of the second diode and the anode of the third diode and the other end connected to the input terminal of the power converting part.

3. The light source driver of claim 2, wherein the multiplying part further comprises a plurality of multiplying cells between the second multiplying cell and the output terminal, and
the second multiplying cell comprises a plurality of second multiplying cells and the plurality of multiplying cells are the plurality of second multiplying cells connected in series.

4. The light source driver of claim 1, wherein the light source is at least one selected from the group consisting of at least one light emitting diode (LED), a fluorescent lamp, or at least one LED array including a plurality of series-connected LEDs.

5. The light source driver of claim 1, wherein the power converting part comprises:
an inductor charging an energy of the input power; and
a switch switching the energy charged in the inductor.
